(19) United States
(12) Patent Application Publication
(10) Pub. No.: US 2020/0405042 A1
(43) Pub. Date: Dec. 31, 2020

(54) METHOD FOR CLEANING A WIDENED INTERDENTAL SPACE AND INTERDENTAL CLEANING BRUSH

(71) Applicant: SOLO-MED GmbH, Trier (DE)

(72) Inventor: Ralf PETERSEN, Bernburg (DE)

(73) Assignee: SOLO-MED GmbH, Trier (DE)

(21) Appl. No.: 16/800,027

(22) Filed: Feb. 25, 2020

Related U.S. Application Data
(63) Continuation-in-part of application No. 16/451,620, filed on Jun. 25, 2019.

(51) Int. Cl. A46B 9/02; A46B 9/04; A61C 15/00

(52) U.S. Cl. CPC A46B 9/028; A46B 2200/108; A61C 15/00; A46B 9/045

(57) ABSTRACT

A method for cleaning the gum in a widened interdental space (14) in which an interdental space brush (6) with a non-circular cross-section (15) of the brush head (7) is inserted into the widened interdental space (14) and moved back and forth.

### BACKGROUND

This invention is directed to a method for cleaning an implant or teeth in a widened interdental space.

A known method for the cleaning of natural teeth in an interproximal embrasure is to insert an interdental space brush with a round cross-section into the interproximal embrasure and move it back and forth. In order to achieve a good cleaning effect, it is important for the interdental space brush to be of correct size. On the one hand, the size can be defined by the diameter of the outer contour. Another dimension is given by the so-called therapeutic width.

The therapeutic width of the interdental space brush is defined by the diameter of a cavity into which the interdental space brush is inserted and within which the filaments fold down as the interdental space brush moves back and forth.

If the filaments are too short or too long in proportion to the cavity, then they cannot fold down. Excessively short or long filaments lead to a poor cleaning effect.

Thus, the therapeutic width may not only depend on the length of the filaments, but also on their flexibility, e.g. on the material and/or the thickness, the diameter of the wire, the material and flexibility of the wire and/or the number of bristles.

In case of implants, the interproximal embrasure may be asymmetrical and/or be widened at the implant.

Periodontitis leads to bone deterioration of the jaw bone in the middle of the interdental space and thus changes the geometry of the interdental space. Therefore also between natural teeth the periodontitis can cause an asymmetrical and/or widened interproximal embrasure.

In both cases, the problem is that cleaning with an interdental space brush with a round cross-section is difficult or impossible because the filaments may not fill the entire widened interproximal embrasure. The use of a brush with a larger therapeutic width may mean that the interdental space brush cannot be inserted into the interproximal embrasure or that, in case of narrower places, the filaments will not fold down and may even damage the gums.

### SUMMARY

The object of this invention is therefore to provide a method of cleaning an implant and/or teeth in a widened interdental space, which allows better and safer cleaning of implants and/or teeth.

This objective is achieved by a method and an interdental space brush having one or more features according to the invention.

The method according to the invention is based on the finding that an implant in an interproximal embrasure cannot be cleaned with an interdental space brush with a round cross-section. In fact, the inventor has found that a non-circular cross-section is necessary for this purpose.

Therefore, the method according to this invention is characterised by the fact that an interdental space brush with a non-circular brush cross-section is inserted into the interdental space and moved back and forth in the longitudinal direction of the brush within the interdental space.

In one embodiment, the brush cross-section of the interdental space brush has a non-circular perimeter and a non-circular area of the perimeter faces the implant during insertion and cleaning.

In one embodiment, the non-circular brush cross-section is characterised by the fact that a round brush cross-section has, at least in one region, a continuous widening, whereby the radius is increased. This results in a widening of the perimeter, which extends into the larger interdental space of the implant or a widening of the interdental space on the implant and ensures adequate cleaning there.

In one embodiment, the perimeter of the brush cross-section of the interdental space brush has at least one segment with an increased therapeutic width and the interdental space brush is inserted into the interdental space such that the segment faces the implant.

In one embodiment of the invention for the cleaning of two adjacent implants, the interdental space brush remains in the interdental space after cleaning the first implant and is turned in such a way that a widened area or a segment faces the second implant.

In one embodiment of the invention, an interdental space brush with two spaced extensions or segments with increased therapeutic width is used for cleaning. As a result, particularly two adjacent implants in the intermediate interdental space can be cleaned in one cleaning process. In this case, the two widened areas or segments should preferably be at an angular distance of 90° to 180° to each other.

In one embodiment, the perimeter of the brush cross-section is eccentric, elliptical or largely rectangular.

In one embodiment, the correct insertion of the interdental space brush into an interdental space is aided by a widening or a segment, and here particularly is oriented on the largest radius or one of the largest radii of the brush cross-section. In this way the interdental space brush can also be introduced into an interdental space in the correct direction without visual inspection, that is, with the widened area facing the implant.

Such a support can be designed as a haptic and/or visual marking.

This marking can be provided on the handle, the bristles and/or the bristle carrier.

The invention further provides a method for cleaning teeth in an interdental space where the jawbone is affected by periodontitis. The method is characterized by the fact that an interdental space brush with a non-circular brush cross-section is inserted into the interdental space and moved back and forth in the longitudinal direction of the brush within the interdental space.

In one embodiment, the brush cross-section of the interdental space brush has a non-circular perimeter and a non-circular area of the perimeter faces the deteriorated jawbone during insertion and cleaning.

In one embodiment, the non-circular brush cross-section is characterised by the fact that a round brush cross-section has, at least in one region, a continuous widening, whereby the radius is increased. This results in a widening of the perimeter, which extends into the larger interdental space of the implant or a widening of the interdental space on the implant and ensures adequate cleaning there.

The invention also provides an interdental space brush with a handle part and a brush head with a brush core with filaments attached, which is particularly suitable for cleaning an implant in an interdental space in accordance with the invention.

In the case of the interdental space brush according to the invention, the cross-section of the brush head has a non-circular perimeter. The interdental space brush according to the invention has at least two different therapeutic widths due to the non-circular perimeter. The interdental space brush can therefore be inserted into an interproximal embrasure in such a way that effective cleaning of the implant surfaces is ensured even in the case of extensions of the interproximal embrasure as they are frequently observed in the case of implants. Therefore, a range of the therapeutic width can be specified for an interdental space brush according to the invention.

Here, the therapeutic width for a round perimeter can be specified as that range of diameters of hollow cylinders where the interdental space brush allows a folding down of the filaments in the hollow cylinder between insertion and subsequent withdrawal. For smaller diameters below the therapeutic width, the filaments do not change their bending direction with the change of direction, but are pulled back with the free end in front. For larger diameters above the therapeutic width, the filaments do not change their bending direction, but at the most they brush the hollow cylinder with their tips in a largely straight alignment of the filaments. This measuring principle can obviously be transferred to non-circular perimeter, e.g. by using tubes with scaled dimensions that are geometrically similar to the perimeter or are otherwise correspondingly shaped. The therapeutic width can thus, for instance, be related to certain sections of the perimeter in such a way that in a typical application situation it is possible to have different therapeutic widths on the right and left sides, e.g. the working side and rear side further discussed below. The invention thus utilises the information that interproximal embrasures between a natural tooth and an implant should best be understood as an eccentric interior space rather than an enlarged symmetrical interior space in order to achieve good cleaning results.

The interdental space brush according to the invention can, for instance, thus be characterised or further improved in that starting from the brush core, a maximum and minimum distance to the perimeter exist, which together more or less form a right angle, i.e. with a deviation of less than 20° or even less than 10°. This basically results in a minimum or a maximum therapeutic width, between which the area of the brush is defined. The condition furthermore defines the geometrical form for the perimeter which is particularly suitable for the cleaning of a widened interproximal embrasure. It is especially favourable if the angle is exactly a right angle.

The interdental space brush according to the invention can also be characterised or further developed in that a minimum measurement of the perimeter on a straight line passing through the brush core is at most two-thirds of a maximum measurement of the perimeter on a straight line passing through the brush core. Here, the dimensions must lie on a straight line passing through the brush core. Here, it is irrelevant whether the perimeter has smaller and/or larger dimensions at other positions. Measured over the brush core, these dimensions can be a minimum and a maximum value of an angle-dependent diameter of the perimeter.

The interdental space brush according to the invention can also be characterised or further developed in that a maximum dimension of the perimeter on a straight line passing through the brush core is divided into a working side and a rear side by the brush core. In this case, the working side is longer than or equal to the rear side. A straight line that is perpendicular to this maximum dimension and passes through the brush core divides the cross-section of the interdental space brush into two areas, where the area in which the working side lies is greater than or equal to half of the total area of the cross-section. In other words, the area in which the working side lies is greater than or equal to the area in which the rear side lies.

In a preferred version of the invention, the brush core divides a maximum dimension of the perimeter on a straight line passing through the brush core into a working side and a rear side. In this case, the working side is longer than or equal to the rear side. In addition, the perimeter has at least one bent area on the working side. The bend provides a better insertion into the interproximal embrasures and any widening of the interproximal embrasure.

It is particularly advantageous if the brush core is eccentrically placed, whereby this particularly refers to the centre of the area within the perimeter. This ensures a good cleaning effect for uneven interproximal embrasures. This especially ensures proper cleaning of the interproximal embrasure on an implant since in comparison to a natural tooth there is retraction at the base of the implant, which forms a widening of the interproximal embrasure. This can be reached well with an eccentric perimeter. The adjacent natural tooth can be cleaned as usual. At an upper contact point between the natural tooth and the implant, the interproximal embrasure forms a space in the form of an approximately isosceles triangle into which the interdental space brush ideally fits, so that the brush core lies on a mid-line of the isosceles triangle. However, in order to reach the widened space by the implant, an eccentric perimeter is particularly favourable.

For an interdental space brush according to the invention, at least one of the aforementioned geometric conditions should ideally be fulfilled. However, several or all conditions can also be fulfilled.

The interdental space brush preferably has a constant outer contour of the brush head, considered along its extension. In this way the manufacturing of the interdental space brush is easy and cost-effective. In order to be able to insert the interdental space brush more easily into an interproximal embrasure, the outer contour for the brush tip can be designed to be tapered, or an insertion area can be placed at the brush tip.

In a preferred version of the invention, the brush core consists of wire or a synthetic material. In this way the interdental space brush can be manufactured easily and cost-effectively.

It is particularly advantageous if the brush core consists of two strands twisted together. Here the filaments in particular can be turned in to the brush core. As a result, manufacturing is particularly easy.

In a particularly advantageous version of the invention, the circumference is eccentric, elliptical or basically rectangular. As a result, the aforementioned geometric conditions are fulfilled and a good cleaning effect is achieved.

As previously described, each brush has a range of therapeutic widths due to the non-circular perimeter. However, an interdental space brush cannot be dimensioned in such a way that it is suitable for all possible interproximal embrasures.

For this reason, it is advisable to provide an interdental space brush set which has at least two interdental space brushes according to the invention, with different sizes. The size is a specification that indicates the range of the therapeutic width of the interdental space brush. Successive interdental space brushes in the set have overlapping therapeutic widths according to the invention. This means that the smallest therapeutic width of an interdental space brush is smaller than the largest therapeutic width of the next smaller interdental space brush in the set. In this way, it is ensured that a suitable interdental space brush is made available for each interproximal embrasure.

In this case, it is particularly advantageous if the set has at least three different sizes.

### BRIEF DESCRIPTION OF THE DRAWINGS

The invention is explained in greater detail below based on some preferred exemplary embodiments with reference to the following drawings.

Shown are:

FIG. 1 a schematic sectional view of a row of teeth with natural teeth,

FIG. 2 FIG. 1 with inserted interdental space brush according to state-of-the-art technology,

FIG. 3 a schematic sectional view of a row of teeth with an implant,

FIG. 4 FIG. 3 with inserted interdental space brush according to state-of-the-art technology,

FIG. 5 a cross-section of an interdental space brush with round perimeter according to state-of-the-art technology,

FIG. 6 a cross-section of an interdental space brush according to the invention with eccentric perimeter,

FIG. 7 the perimeter of the interdental space brush of FIG. 6 with marked minimum and maximum distances,

FIG. 8 the perimeter of the interdental space brush of FIG. 6 with marked minimum and maximum dimensions and areas,

FIG. 9 FIG. 3 with inserted interdental space brush according to the invention as per FIG. 6,

FIG. 10 an interdental space brush according to the invention with oval perimeter,

FIG. 11 an interdental space brush according to the invention with elliptical perimeter,

FIG. 12 an interdental space brush according to the invention with primarily rectangular perimeter,

FIG. 13 a schematic side view of an interdental space brush according to the invention,

FIG. 14 a flow chart of a method according to the invention,

FIG. 15 a schematic cross sectional view of an interproximal embrasure between two natural teeth with a regular interdental space brush inserted,

FIG. 16 a schematic cross sectional view of a widened interproximal embrasure between two natural teeth with a regular interdental space brush inserted where the jaw bone is deteriorated due to periodontitis, and

FIG. 17 the schematic cross sectional view of FIG. 16 with an interdental space brush with non-circular circumference.

### DETAILED DESCRIPTION

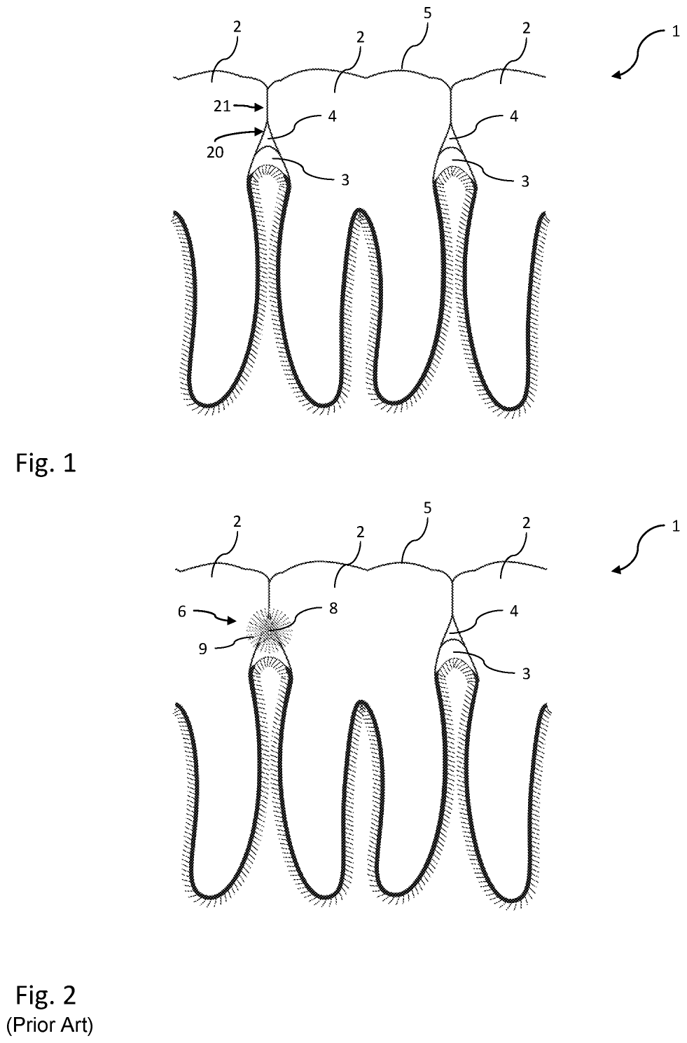

FIG. 1 shows a diagram of a row of teeth 1 with natural teeth 2. Between two teeth 2 and the gum 3, an interproximal embrasure 4 is formed in each case, which in the example exhibits an approximately triangular opening.

In the example shown, adjacent teeth 2 touch respectively at a contact point 21. But even with non-contacting teeth 2, a corresponding interproximal embrasure 4 is formed, which is then open to the tooth top edge 5. In the upper area of the interproximal embrasure 4, the teeth which touch or approach each other 2, form a space 20 with a basic inner contour of an isosceles triangle.

For cleaning the teeth 2 in the interproximal embrasure 4, use of an interdental space brush 6 is a known method according to state-of-the-art technology. Such an interdental space brush 6 has a brush head 7 with a brush core 8 and filaments 9 attached to it. The brush core 8 is connected to a handle 18.

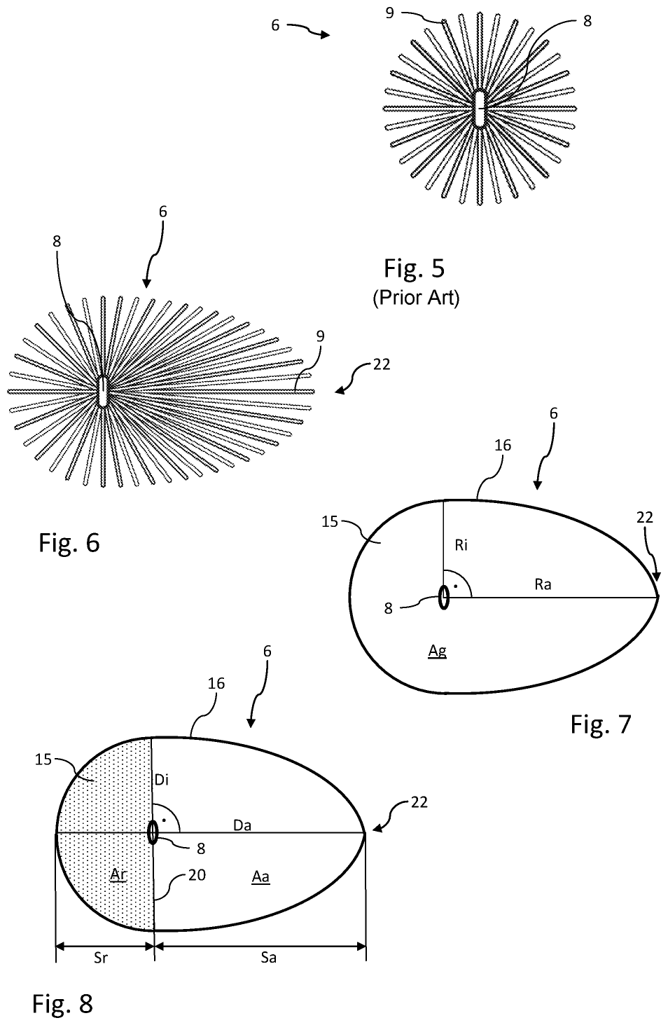

For example, the filaments 9 form a cylindrical outer contour with a round cross-section, as shown in FIG. 5. Such an interdental space brush 6 is inserted into the interproximal embrasure 4 and moved back and forth so that the filaments 9 clean the tooth surfaces in the interproximal embrasure 4.

As can be seen in FIG. 2, such an interdental space brush 6 completely fills an interproximal embrasure 4 between two natural teeth 2. This means that the filaments 9 reach each spot of the teeth 2 in the interproximal embrasure 4, thus ensuring complete cleaning.

Here the brush core 8 is placed on a mid-line of the space 20 or the corresponding triangular convergence in this space 20.

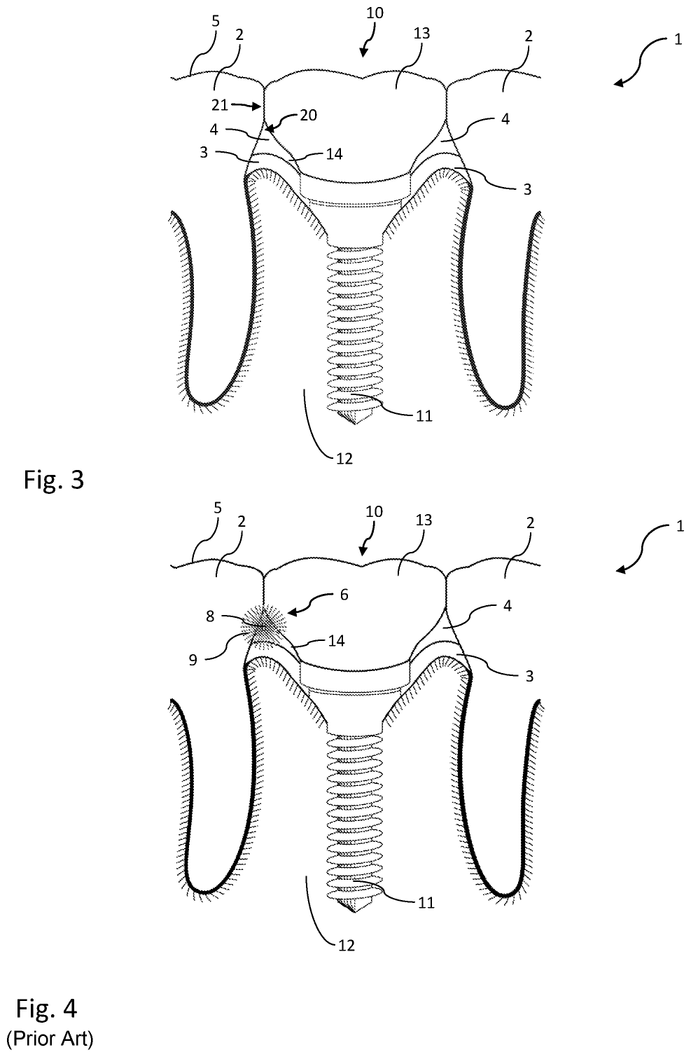

FIG. 3 now shows a schematic representation of a row of teeth 1 with an implant 10. The implant 10 has an implant body 11, which is fixed in the jaw bone 12. An implant abutment (cannot be seen here) is placed in the implant body 11, on which an implant crown is 13 is fixed.

However, the interproximal embrasure 4 here has a widening 14 in the area of contact between implant crown 13 and implant body 11 since the implant crown 13 does not fit as tightly in the gum 3 as a natural tooth 2.

The shape of the mentioned space 20 is only marginally deformed here. The user is therefore most comfortable with a position of the interdental space brush 6, in which the brush core 8 is located centrally with respect to the space 20.

As shown in FIG. 4, the filaments 9 of a conventional interdental space brush 6 with a round cross-section do not extend into the widening 14 of the interproximal embrasure 4. Therefore, complete cleaning of implant 10 in this widening 14 is not possible with such an interdental space brush 6. This problem cannot generally be resolved by choosing an interdental space brush 6 with larger cross-section as the interdental space brush 6 can then be altogether too large to be inserted into the interproximal embrasure 4.

In order to fill this widening 14 of the interproximal embrasure 4, an interdental space brush 6 has a non-circular cross-section 15 according to the invention.

The first example of an interdental space brush version 6 according to the invention is shown in FIG. 6. Here the interdental space brush has a cross-section 15 which can basically be described as eccentric.

A diagram of the perimeter 16 of cross-section 15 of the interdental space brush 6 is shown in FIG. 7. Starting from the brush core 8, there is a minimum distance Ri to the perimeter 16 and a maximum distance Ra to the perimeter 16, which together form a right angle. The geometry of the circumferential contour 16 of the interdental space brush 6 is defined by this condition so that a good cleaning effect can be achieved. The cross-section 15 basically has a round form with radius Ri, which has an increased radius Ra at one point. The perimeter 16 runs continuously around this radius Ra and forms a constant widening 22 of the perimeter 16.

FIG. 8 also shows the perimeter 16 of FIG. 7 with a maximum dimension Da of the perimeter 16 on a straight line through the brush core 8. The brush core 8 divides this dimension Da into a working side Sa and a rear side Sr, with Sa≥Sr. A minimum dimension Di is furthermore marked on a straight line through the brush core 8. An alternative or concurrent geometrical condition is required for the minimum dimension Di and the maximum dimension Da, that is: Di≤⅔ Da. In other words, the minimum dimension Di is at most two thirds of the maximum dimension Da.

It is essential that the dimensions Da and Di are each selected on a straight line through the brush core 8. Here it is irrelevant whether the perimeter 16 still has larger or smaller dimensions at other points. The minimum distance Di must not be orthogonal to the maximum distance Da either. This is only the case in the example shown.

An alternative or concurrent geometrical condition which also uses the maximum dimension Da, can be that a straight line 20 that is orthogonal to the maximum dimension Da divides the total area Ag of the perimeter into two sub-areas. It must now be the case that the area Aa, containing the working side Sa, is greater than or equal to the area Ar, containing the rear side Sr. In other words, the area Aa is greater than or equal to half of the total area Ag.

In this case, it is only important that the dividing straight line 20 is orthogonal to the maximum dimension Da and passes through the brush core 8. The length or the dimension of the straight line 20 does not play any role.

In addition, the brush core 8 is not arranged centrally in this version of the invention, whereby the reference point of the area centre of the circumferential area Ag is thus the area enclosed by the perimeter 16. This can also be a decisive criterion for the interdental space brush 6.

All the mentioned criteria can be applied separately or in any combination in order to find a suitable perimeter for the interdental space brush. All criteria are met simultaneously with the eccentric form shown here, which is why this is a preferred version.

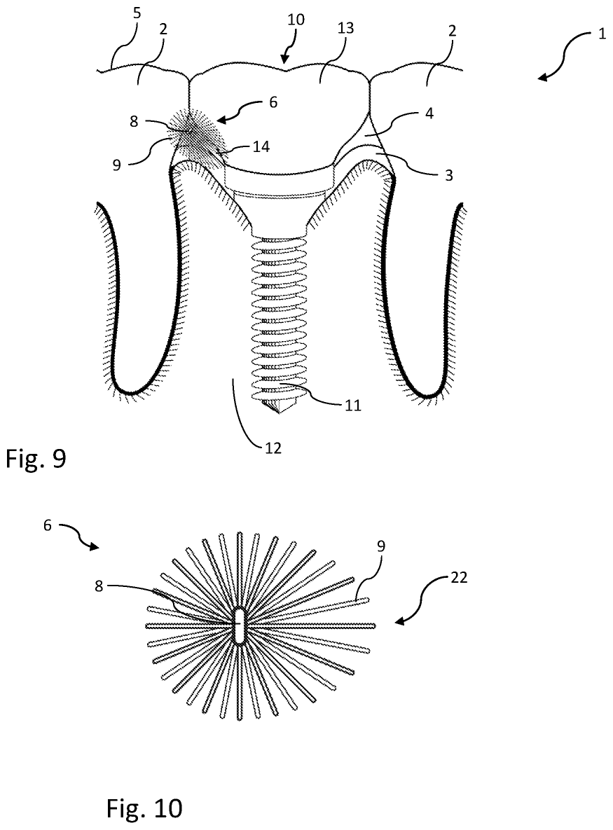

In FIG. 9, the interdental space brush 6 of FIG. 6 is now inserted into the interproximal embrasure 4 of FIG. 3 in such a way that the longer working side points into the widening 14 of the interproximal embrasure 4. As can be seen here, the interdental space brush 6 according to the invention fills the complete interproximal embrasure 4, including the widening 14, in such a way that the implant 10 can be completely cleaned.

The previously described geometrical conditions are applicable for the geometry of the perimeter 16 and thus the outer contour of the interdental space brush 6. This permits different forms, of which further possible forms are shown in FIGS. 10 to 12. Basically, the perimeter 16 of FIG. 10 can be described as oval. This shape may be convenient for less pronounced widening 14.

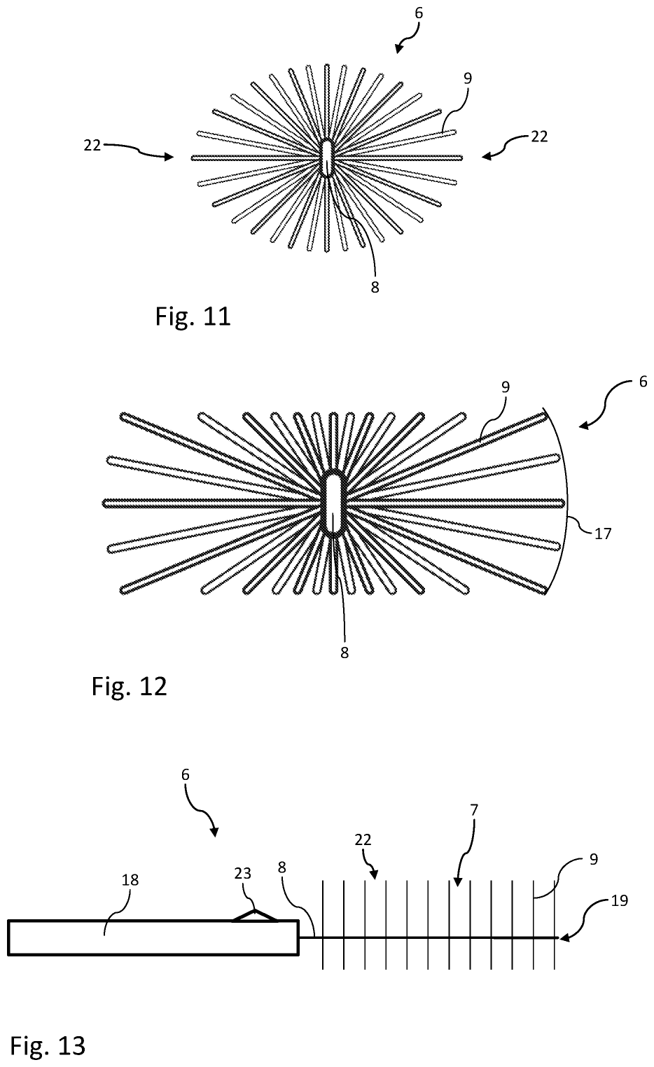

The perimeter 16 of the interdental space brush 6 can also be designed symmetrically as shown in FIG. 11. Such geometry may be advantageous if, for example, in a row of teeth 1 several implants 10 lie next to each other and/or an interproximal embrasure 4 is widened on both sides 14 or is very irregular in shape.

The geometrical conditions also generally allow rectangular shapes, as shown in FIG. 12 for example. It is important that the perimeter 16 has a bend 17 on at least one working side. This bend 17 ensures that an interproximal embrasure 4 and a possible widening 14 are definitely filled so as to give a good and complete cleaning effect.

FIG. 13 shows an example of an interdental space brush 6 according to the invention. This interdental space brush 6 has a brush head 7 with a brush core 8 and filaments 9 attached to it. The brush core 8 consists of two wire strands, for example, which are twisted together, whereby the filaments 9 are turned in between the wire strands. The brush core 8 is connected to a handle 18. The brush head 7 has an oval shaped perimeter as shown in FIG. 6. For this reason longer filaments 9 are shown in the diagram on the upper side of the brush core 8 than on the lower side.

In addition, the interdental space brush 6 has an aid for correct insertion. This aid is shown here by an elevation 23 on the handle 18, which is aligned with the longer filaments 9 and thus the widening 22 of the perimeter.

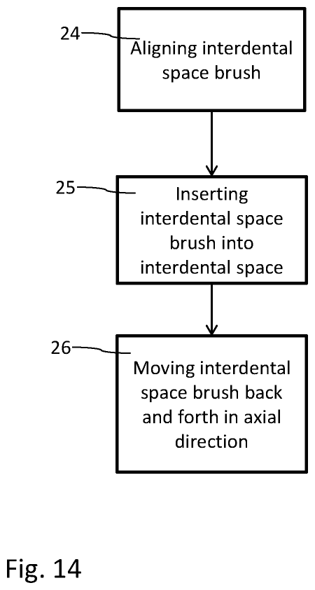

FIG. 14 shows a flow chart of a cleaning method according to the invention. Initially, in an alignment step 24, an interdental space brush 6 of the appropriate size is aligned with respect to the implant 10. A non-circular point or widening 22 of the interdental space brush 6 is aligned here in such a way that it faces the implant 10 to be cleaned. Haptic and/or visual marking 23 on the interdental space brush 6 can be helpful in this case.

In an insertion step 25, the interdental space brush 6 is inserted into the interproximal embrasure 4. Depending on the application, the alignment step 24 can also take place after the insertion 25, in which the interdental space brush 6 is turned in the interproximal embrasure 4 in such a way that a widening 22 is in a widened area 14 of the interproximal embrasure 4. This can possibly be felt through a reduced resistance.

In the subsequent cleaning step 26, the interdental space brush 6 is moved back and forth along its longitudinal alignment within the interproximal embrasure 4 until the desired cleaning effect is achieved. This can be the case after a predetermined time. The interdental space brush 6 can subsequently be removed again.

FIG. 15 shows a cross section of a jaw between two natural teeth 2. The teeth 2 touch each other in a contact area 21. The jaw bone 12 is healthy and the gum 3, covering the jaw bone 12, and the contact area 21 define an interproximal embrasure 4. In this case, a regular interdental space brush 6 with filaments 9 with a circular circumference can easily be inserted and used for cleaning. As is shown in FIG. 15 the filaments 9 reach the gum 3 at all areas.

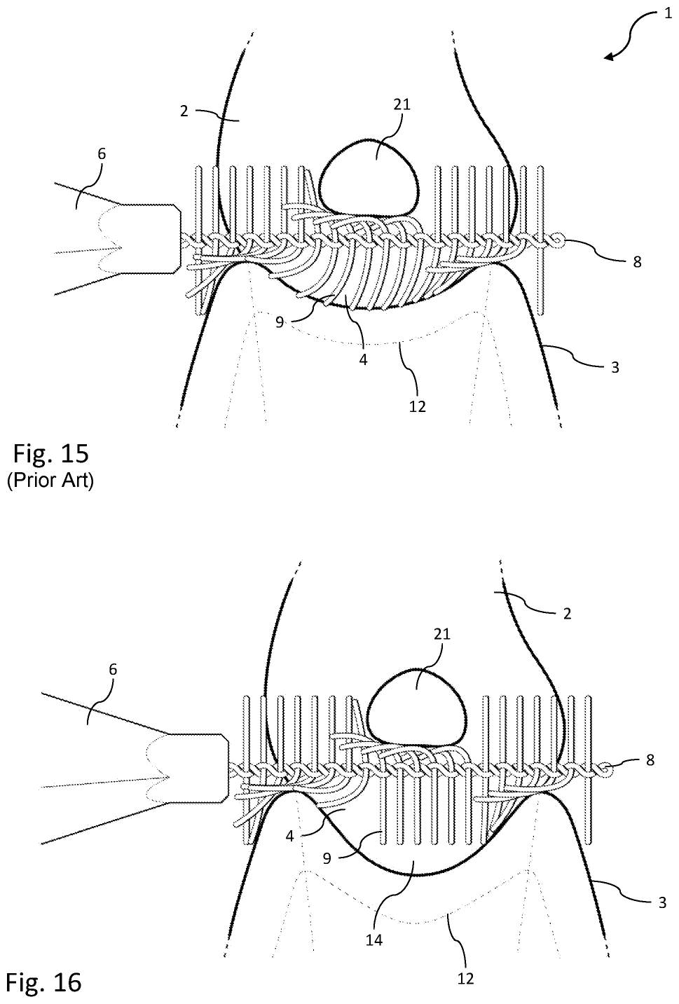

FIG. 16 shows a cross section of a jaw similar to FIG. 15. Here the jaw bone 12 is deteriorated due to periodontitis. This leads to a widened interproximal embrasure 14. When a circular interdental space brush 6 is inserted in such a widened embrasure 14, the filaments 9 cannot reach the gum 3 at the widened area. The area of the gum affected by periodontitis is not cleaned by such a regular interdental space brush 6 which worsens the effect.

One obvious solution would be to use an interdental space brush 6 with larger diameter. However, a brush 6 with filaments 9 long enough to reach the gum 3 in the affected area 14 could be too large for insertion due to the contact area 21.

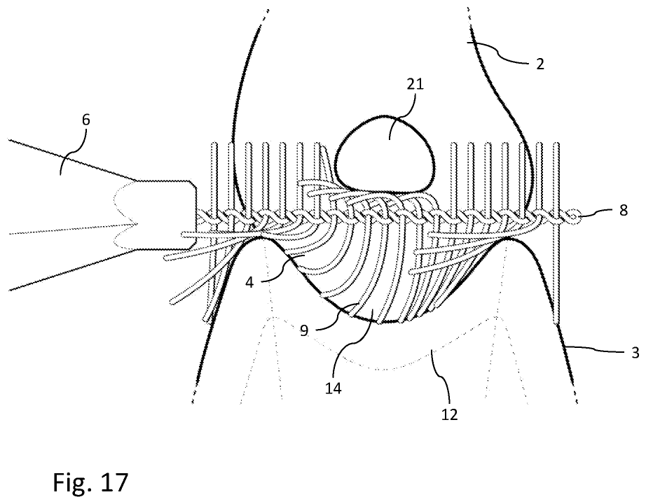

The inventor realized that for cleaning such widened interproximal embrasures 14 the same principle applies as for implants. The solution for cleaning periodontitis affected interproximal embrasures 14 is using an interdental space brush 6 with non-circular circumference as described for example in FIGS. 6 to 10. FIG. 17 shows the jaw of FIG. 16 with such a non-circular interdental space brush 6 inserted. The key is to position the brush 6 so that the longer filaments 9 are aligned with the widening of the embrasure 14. That means basically that the longer part of the brush 6 is facing the jaw bone 12.

In this case the filament 9 on the side of the contact area 21 are short enough that the brush 6 can be inserted in the embrasure 14. And filaments 9 facing the jaw bone 12 are long enough to reach the gum 3 in the widened embrasure 14. When moving the brush 6 back and forth in the axial direction of the brush, the spring effect of the filaments 9 works and the cleaning is performed effectively.

### LIST OF REFERENCE SIGNS

1 Row of teeth
2 Tooth
3 Gum
4 Interproximal embrasure
5 Tooth top edge
6 Interdental space brush
7 Brush head
8 Brush core
9 Filaments
10 Implant
11 Implant body
12 Jaw bone
13 Implant crown
14 Widening of interproximal embrasure
15 Cross-section of brush head
16 Perimeter
17 Bend
18 Handle
19 Brush tip
20 Space
21 Contact point/area
22 Widening
23 Marking
24 Alignment step
25 Insertion step
26 Cleaning step
Ag Total area within the perimeter
Ar Area of the rear side
Aa Area of the working side
Sr Rear side
Sa Working side
Di Minimum dimension
Da Maximum dimension
Ri Minimum distance
Ra Maximum distance

1. A method for cleaning a gum in a widened interdental space (14), the method comprising:
inserting an interdental space brush (6) with a non-circular brush cross-section (15) into the interdental space (4); and
moving the interdental space brush (6) back and forth in a longitudinal direction of the brush within the interdental space (4) for cleaning.

2. The method according to claim 1, further comprising facing a non-circular part of the brush cross-section (15) having longer brush bristles toward the gum of a user during at least one of the insertion or the cleaning.

3. The method according to claim 1, further comprising the non-circular brush cross-section (15) being formed as a result of a round brush cross-section having a constant widening in at least one region (22) in which a radius is increased.

4. The method according to claim 1, further comprising a perimeter (16) of the brush cross-section (15) of the interdental space brush (6) having at least one segment with an increased therapeutic width that defines a widening (22) and the inserting of the interdental space brush (6) into the widened interdental space (14) is carried out such that the segment with the widening (22) faces the gum of a user.

5. The method according to claim 4, wherein the perimeter (16) is eccentric, elliptical or generally rectangular.

6. The method according to claim 4, further comprising providing the interdental space brush (6) with an aid (23) aligned with a widening (22) of the brush cross-section (15) for correct insertion.

7. The method according to claim 6, wherein the aid (23) comprises at least one of a haptic or visual marking.
